(19) United States
(12) Patent Application Publication
(10) Pub. No.: US 2011/0250483 A1
(43) Pub. Date: Oct. 13, 2011

(54) BATTERY LATCHING MECHANISM FOR PORTABLE ELECTRONIC DEVICE

(75) Inventor: XIAO-HUA LIU, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/788,447

(22) Filed: May 27, 2010

(30) Foreign Application Priority Data
Apr. 9, 2010 (CN) 201020154737.6

(51) Int. Cl. H01M 2/10

(52) U.S. Cl. 429/97

(57) ABSTRACT

A portable electronic device includes a printed circuit board, a battery, a housing, and at least one latching element. The housing defines a battery compartment to receive an inserted battery and forms at least one positioning portion. The at least one latching element is mounted on the positioning portion and resists the battery.

### BACKGROUND

1. Technical Field

The present disclosure relates to battery latching mechanisms and, particularly relates to a battery latching mechanism used in a portable electronic device.

2. Description of Related Art

Battery latching mechanisms are usually provided to secure batteries within portable electronic devices. As the demand for multifunctional portable electronic devices rises, batteries of portable electronic devices are desired to be more powerful to satisfy high demands of users. However, powerful batteries are usually large and heavy, thus strong latching mechanisms are needed. Additionally, when installing the battery and securing it with the latching mechanism, the force used may cause the battery to impact with internal parts of the device such as a printed circuit board and shorten the life of the device from the wear and tear caused to the board.

To move the battery for recharging, the operator must first use sufficient force to release the strong latching mechanism and then separate the battery from the portable electronic device. It can be inconvenient and time consuming to replace the battery.

Therefore, there is room for improvement within the art.

### BRIEF DESCRIPTION OF THE DRAWINGS

Many aspects of the exemplary battery latching mechanism can be better understood with reference to the following drawings. The components in the drawings are not necessarily drawn to scale, the emphasis instead being placed upon clearly illustrating the principles of the battery latching mechanism for portable electronic device. Moreover, in the drawings, like reference numerals designate corresponding parts throughout the several views, in which:

FIG. 1 is an exploded, isometric view of an exemplary embodiment of a portable electronic device;

FIG. 2 is similar to FIG. 1, but viewed from another aspect;

FIG. 3 is an assembled, isometric view of the portable electronic device of FIG. 1; and

FIG. 4 is an assembled, isometric view of the portable electronic device of FIG. 1, showing a battery latched in the portable electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

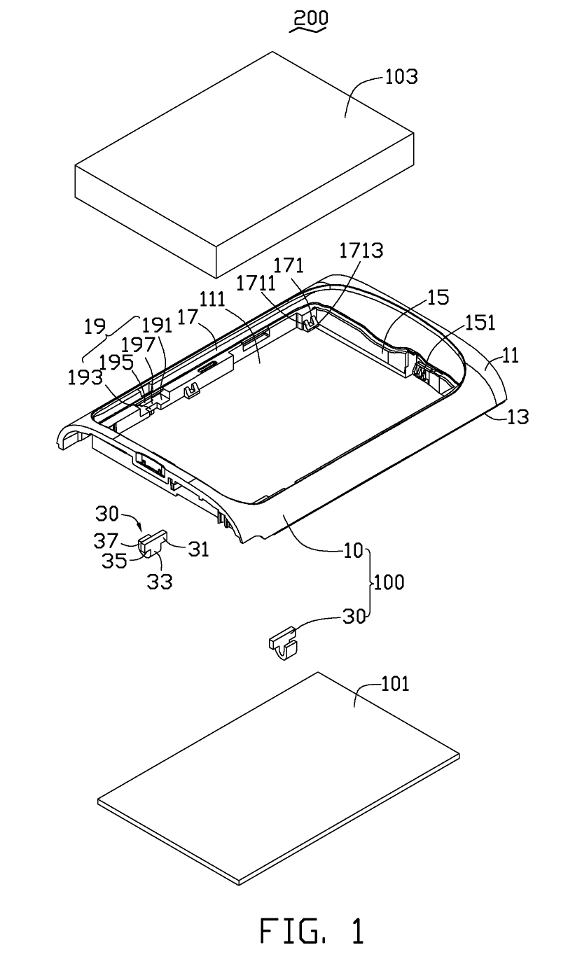

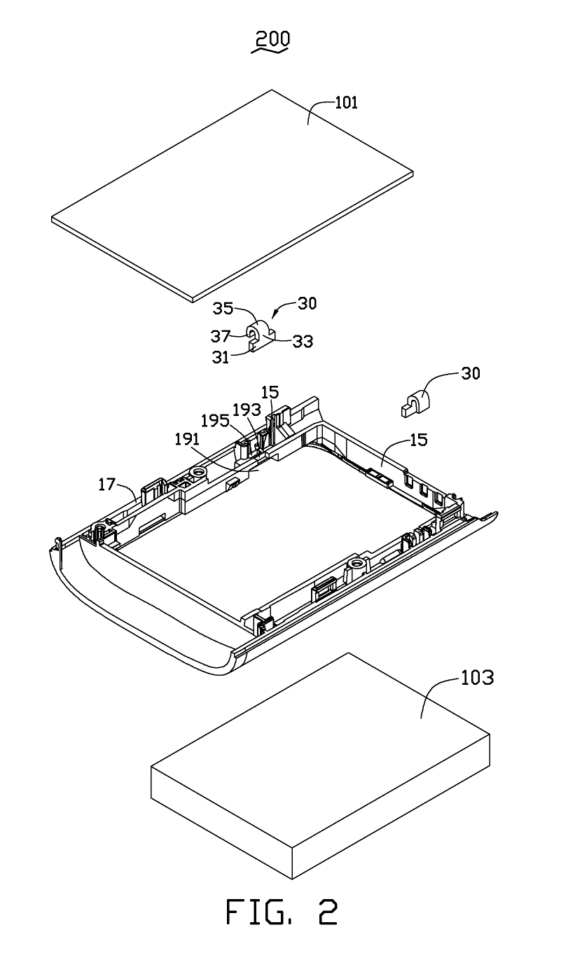

FIGS. 1 and 2 show an exemplary embodiment of a portable electronic device 200, such as a cellular phone, a personal digital assistant (PDA), or a game player, where a battery is desired. The portable electronic device 200 includes a battery latching mechanism 100, and a printed circuit board 101 (PCB), and a battery 103. The battery latching mechanism 100 includes a housing 10 and two latching elements 30. The housing 10 defines a battery compartment 111 to receive the battery 103. The latching elements 30 elastically resist the battery 103 to secure the battery 103 in the battery compartment 111.

The housing 10 includes a first surface 11 and a second surface 13 opposite to the first surface 11. The battery compartment 111 is defined in the first surface 11 and is bounded by two end portions 15 and two sidewalls 17. A plurality of contacts 151 are mounted to one of the end portions 15. The contacts 151 are for electrically connecting to the battery 103 when the battery 103 is received in the battery compartment 111 to supply power for the portable electronic device 200. A plurality of positioning blocks 171 protrude from each of the sidewalls 17, and extend into the battery compartment 111. Each positioning block 171 is substantially a wedge-shaped block, and includes a resisting surface 1711 and a base portion 1713. The resisting surface 1711 is angled from the base portion 1713. The base portion 1713 spaces the battery 103 from the PCB.

The interior of each sidewall 17, adjacent to the battery compartment 111, defines a groove 191. The bottom surface of the groove 191 defines a slot 193 and a receiving hole 195. The receiving hole 195 is substantially parallel to the slot 193. A latching beam 197 is formed between the slot 193 and the receiving hole 195 so that the slot 193 and the receiving hole 195 are separated from each other. The groove 191, the slot 193, the receiving hole 195, and the latching beam 197 form a positioning portion 19 for mounting one of the latching elements 30.

The latching elements 30 each are integrally formed by e.g., molding or punching. Each of the latching elements 30 includes a latching portion 31, a first resisting portion 33, a connecting portion 35, and a second resisting portion 37. The first resisting portion 33 perpendicularly projects form the latching portion 31 and substantially parallels to the second resisting portion 37. The connecting portion 35 is generally U-shaped.

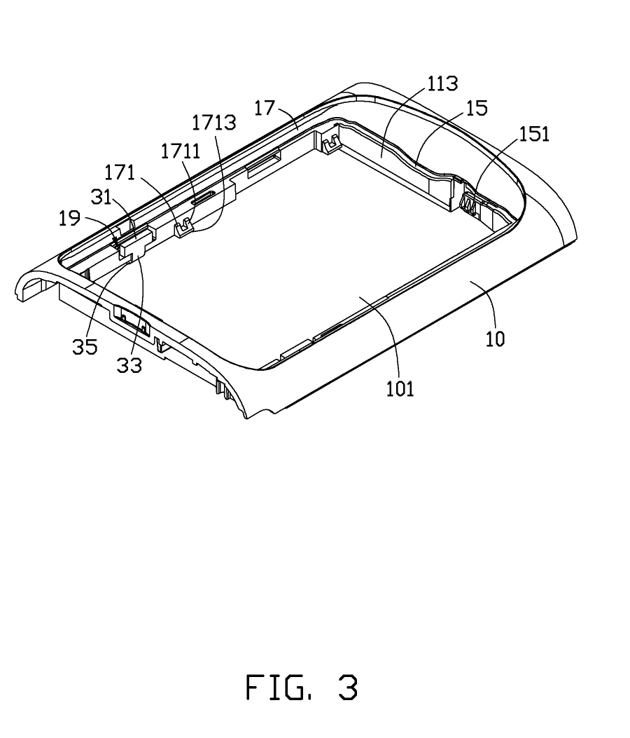

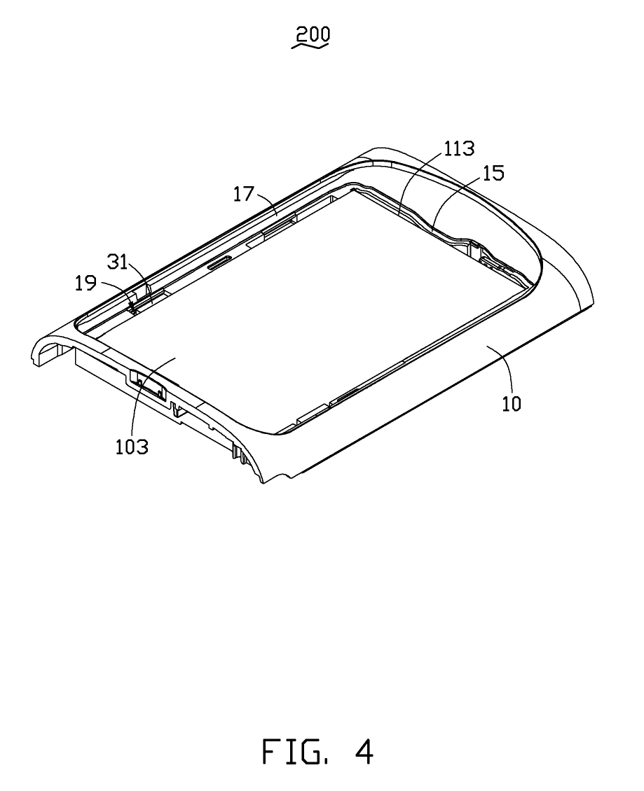

Referring to FIGS. 3 and 4, during assembly, the PCB 101 is attached to the housing 10 by e.g., a suitable fastener (not illustrated), such as a bolt, or by heat-melting. The PCB 101 shields one portion of the battery compartment 111. One of the latching elements 30 is mounted on one of the positioning portions 19. The second resisting portion 37 of the latching element 30 is inserted into the receiving hole 195, and the first resisting portion 33 is received in the slot 193. The latching portion 31 is received in the groove 191, and the connecting portion 35 resists the latching beam 197. The process of assembly of the other latching element 30 is generally the same as described above. Thus, the portable electronic device 200 is assembled. When the battery 103 is received in the battery compartment 111, the resisting surfaces 1711 of the positioning blocks 171 support the battery 103, and there is a space between the battery 103 and the PCB 101, which is approximately equal to the height of the base portions 1713. The battery 103 is then elastically resisted by the first resisting portion 33 and the latching portion 31 of each latching element 30.

The portable electronic device 200 has two latching elements 30 elastically resisting and limiting the battery 103 so that the battery 103 can be retained in the battery compartment 111. Furthermore, the resisting surfaces 1711 resist the battery 103 and there is a space between the battery 103 and the PCB 101 so that any impact caused by assembling the battery 103 into the device does not damage the PCB 101.

It is to be understood that the quantity of the positioning blocks 171 can be more than two. Further, the number of the latching element 30 can be varied according to different conditions, such as one or more than two, accordingly, the number of the positioning portion 19 makes according change.

It is believed that the present embodiments and their advantages will be understood from the foregoing description, and it will be apparent that various changes may be made thereto without departing from the spirit and scope of the disclose or sacrificing all of its material advantages, the examples hereinbefore described merely being preferred or exemplary embodiments of the disclosure.

What is claimed is:

1. A portable electronic device comprising:
a printed circuit board;
a battery;
a housing defining a battery compartment to receive the battery and forming at least one positioning portion;
at least one latching element mounted on the positioning portion and resisting the battery.

2. The portable electronic device as claimed in claim 1, wherein the housing includes two sidewalls, at least one positioning block projects from each of the sidewalls, the positioning blocks support the battery to separate the battery from the printed circuit board.

3. The portable electronic device as claimed in claim 2, wherein the positioning blocks each comprise a resisting surface and a base portion, the battery resists the resisting surfaces, the base portions allows the battery to be spaced from the printed circuit board.

4. The portable electronic device as claimed in claim 2, wherein each of the positioning portions includes a groove, a slot, a receiving hole defined in the sidewall, and a latching beam formed between the slot and the receiving hole.

5. The portable electronic device as claimed in claim 4, wherein the at least one latching element comprises a latching portion, a first resisting portion, and a second resisting portion, the latching portion is received in the groove, the first resisting portion is received in the slot, and the second resisting portion is received in the receiving hole.

6. The portable electronic device as claimed in claim 5, wherein the at least one latching element further comprises a U-shape connecting portion, the connecting portion connects the first resisting portion to the second resisting portion, the first resisting portion parallels to the second resisting portion.

7. The portable electronic device as claimed in claim 1, wherein the housing includes an end portion, a plurality of contacts mounted on the end portion, the contacts are electrically connected to the printed circuit board.

8. A battery latching mechanism for securing a battery to a portable electronic device comprising:
a housing defining a battery compartment and forming at least one positioning portion;
at least one latching element mounted on the positioning portion and for resisting an inserted battery to allow the battery to be spaced from a printed circuit board of the portable electronic device.

9. The battery latching mechanism as claimed in claim 8, wherein the housing includes two sidewalls, at least one positioning block projects from each of the sidewalls, the positioning blocks support the battery to separate the battery from a printed circuit board attached the housing.

10. The battery latching mechanism as claimed in claim 9, wherein the positioning blocks each comprise a resisting surface to resist the battery and a base portion, the base portion is for defining a space between the battery and the printed circuit board.

11. The battery latching mechanism as claimed in claim 9, wherein the sidewalls each define a groove, a slot, and a receiving hole, a latching beam is formed between the slot and the receiving hole, the groove, the receiving hole and the latching beam together form the positioning portion.

12. The battery latching mechanism as claimed in claim 11, wherein the at least one latching element comprises a latching portion, a first resisting portion, and a second resisting portion, the latching portion is received in the groove, the first resisting portion is received in the slot, and the second resisting portion is received in the receiving hole.

13. The battery latching mechanism as claimed in claim 12, wherein the at least one latching element further comprises a U-shape connecting portion, the connecting portion connects the first resisting portion to the second resisting portion, the first resisting portion parallels to the second resisting portion.
